(19) United States
(12) Patent Application Publication
(10) Pub. No.: US 2018/0022630 A1
(43) Pub. Date: Jan. 25, 2018

(54) MOLD, MOLDING APPARATUS, AND PRODUCTION METHOD OF BENT GLASS

(71) Applicant: ASAHI GLASS COMPANY, LIMITED, Chiyoda-ku (JP)

(72) Inventors: Takanori FUKUSHI, Tokyo (JP); Satoshi KANASUGI, Tokyo (JP); Makoto FUJII, Tokyo (JP); Junji HORI, Tokyo (JP)

(73) Assignee: ASAHI GLASS COMPANY, LIMITED, Chiyoda-ku (JP)

(21) Appl. No.: 15/653,994

(22) Filed: Jul. 19, 2017

(30) Foreign Application Priority Data
Jul. 22, 2016 (JP) 2016-144762

(51) Int. Cl. C03B 23/035; C03B 23/025; C03C 21/00

(52) U.S. Cl. CPC C03B 23/0357; C03C 21/002; C03B 23/025; C03B 2215/05

(57) ABSTRACT

A mold has a molding surface for hot molding of a body to be molded. The mold includes a glass having a porosity of 0.01% or more and containing 95 mol % or more of SiO₂. A molding apparatus includes the mold. A method for producing a bent glass includes a placing step and a molding step. In the placing step, a glass to be molded is placed on a mold including a glass having a porosity of 0.01% or more. In the molding step, the glass to be molded which has been placed on the mold is heated, and then, the glass is caused to be molded to follow a molding surface of the mold.

### CROSS-REFERENCE TO RELATED APPLICATIONS

This application claims priority from Japanese Patent Application No. 2016-144762 filed on Jul. 22, 2016, the entire subject matter of which is incorporated herein by reference.

### BACKGROUND OF THE INVENTION

### Technical Field

The present invention relates to a mold, a molding apparatus, and a production method of a bent glass.

### Background Art

For example, some of bent glasses at least partially having a curvature part, such as cover glass for in-vehicle displays, is produced through a molding step of heating a sheet glass placed on a mold to a temperature not less than the softening point and changing the shape to follow a molding surface of the mold.

Patent Document 1 discloses a method in which a sheet glass is placed on a mold formed of silicon carbide or other materials, followed by heating by a radiation heater and molding to provide a desired surface shape. In addition, Patent Document 2 describes that a mold is produced by using SiO₂, Al₂O₃, a carbon material, etc.

Patent Document 1: Japanese Patent No. 5479468

Patent Document 2: U.S. Pat. No. 9,067,813

### SUMMARY OF THE INVENTION

The mold material described in Patent Document 1 has high durability, but the material itself is expensive. In addition, since the mold is composed of a high-strength material, the processability is low, giving rise to a problem that fabrication of a large mold is difficult. On the other hand, the carbon material described in Patent Document 2 is inexpensive, lightweight and easy to process, and a large mold can be easily and simply produced at a low cost. However, when a glass is molded using this carbon mold, a mold-induced defect due to dust from the carbon material is readily occurred. Furthermore, the carbon mold can be hardly applied to a step of performing the molding in an air atmosphere, because oxidation readily proceeds during the molding, and the molding needs to be performed in a vacuum or an inert gas atmosphere such as N₂ gas. Accordingly, the molding process or the molding apparatus becomes cumbersome, and it is disadvantageously difficult to enhance the productivity.

In an aspect of the present invention, an object thereof is to provide a mold, a molding apparatus, and a production method of a bent glass, ensuring that a glass having no molding defect can be simply and easily produced while raising the productivity.

An aspect of the present invention includes the following embodiments.

(1) A mold having a molding surface for hot molding of a body to be molded,

the mold comprising a glass having a porosity of 0.01% or more and containing 95 mol % or more of SiO₂.

(2) A molding apparatus comprising the mold according to (1).

(3) A method for producing a bent glass, the method comprising:

a placing step of placing a glass to be molded, on a mold comprising a glass having a porosity of 0.01% or more; and

a molding step of heating the glass to be molded which has been placed on the mold, thereby causing the glass to be molded to follow a molding surface of the mold.

Permeability of a gas in a space between a body to be molded and a mold can be ensued during the molding, and the occurrence of molding failure due to a gas remaining between the body to be molded and the mold can be prevented. Furthermore, a molded body having no molding defect and having a curvature part can be simply and easily produced while raising the productivity.

### BRIEF DESCRIPTION OF THE DRAWINGS

FIG. 1 is a cross-sectional view of a mold in an aspect of the present invention.

FIG. 2 is a schematic configuration diagram of a molding apparatus mounted with the mold illustrated in FIG. 1.

FIG. 3 is a flowchart illustrating the procedure of the production process of a bent glass.

FIG. 4 is a cross-sectional view of a main part of a molding apparatus illustrating a second configuration example of a mold.

FIG. 5 is a cross-sectional view of a main part of a molding apparatus illustrating a third configuration example of a mold.

FIG. 6 is cross-sectional views of a main part of a molding apparatus illustrating a fourth configuration example of a mold.

### DETAILED DESCRIPTION OF THE INVENTION

Embodiments of the present invention are described in detail below by referring to the drawings.

### First Configuration Example

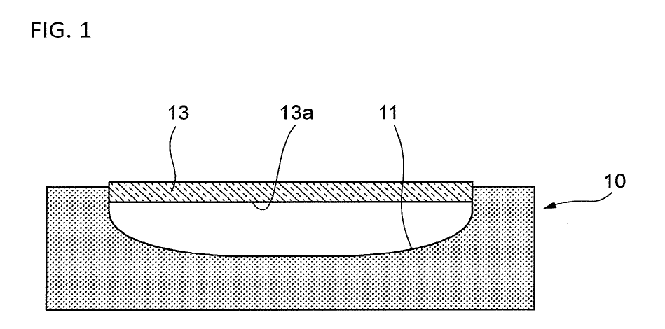

FIG. 1 shows a cross-sectional view of the mold of this embodiment.

The mold 10 for molding a bent glass has a concave molding surface 11 on the top surface. The molding surface 11 has the same surface shape as the design shape of a bent glass having a curvature part.

A glass to be molded 13 as a body to be molded is placed on the mold 10, and the glass to be molded 13 is heated to a temperature not less than the softening point. The heated glass to be molded 13 deforms along the molding surface 11 due to softening by heating and the later-described exterior force such as gravity, suction power and pressing force, and a first main surface 13a abuts the molding surface 11 of the mold 10. The shape of the molding surface 11 is thereby transferred to the glass to be molded 13. The glass to be molded 13 is preferably heated such that the equilibrium viscosity becomes from 10^{6.5} Pa·s to 10^{12.5} Pa·s. The equilibrium viscosity is more preferably from 10⁷ Pa·s to 10¹⁰ Pa·s. When the equilibrium viscosity falls within the range above, the flatness, etc. of the molding surface are maintained, so that optical quality can be retained and the deviation from the desired design dimension can be reduced.

The equilibrium viscosity can be measured by, e.g. beam bending method (ISO 7884-4: 1987), fiber elongation viscometer method (ISO 7884-3: 1987), parallel plate viscometer (ASTM C338-93: 2003), or sinking bar viscometer (ISO 7884-5: 1987).

The body to be molded which has a curvature part as used in the present specification means a body to be molded, such as a glass, partly having a bent portion, or a body to be molded which has a curved part formed in whole or in part of the main surface or the end face. The body to be molded is not limited only to a plate-like body but may also be a body to be molded which has a somewhat curved portion, a block shape, or a non-uniform thickness. The radius of curvature of the curvature part is preferably from 10 mm to 10,000 mm. In the following description, the glass as a body to be molded before molding is referred to as a glass to be molded, and the glass as a body to be molded after molding is referred to as a bent glass.

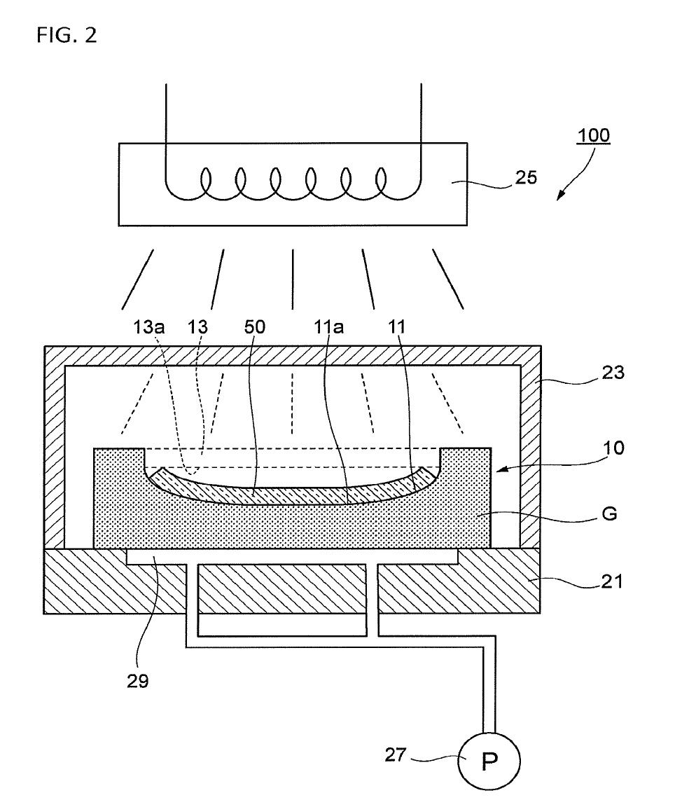

FIG. 2 shows a schematic configuration diagram of a molding apparatus mounted with the mold 10 illustrated in FIG. 1.

The molding apparatus 100 includes the mold 10, a base 21, a cover member 23, a heater 25, and a suction pump 27.

As described above, the mold 10 has a molding surface 11 for molding a first main surface 13a of the glass to be molded 13 into a desired shape. More specifically, the mold 10 has a concave part for molding the designed bent glass 50 and is formed of a glass material. Here, the mold 10 is not limited to a mold having the above-described concave part but the mold may have a convex part, and this is not particularly limited.

The mold 10 is produced using a glass G having a porosity of 0.01% or more, preferably from 0.01% to 40%, more preferably from 0.01% to 20%.

The porosity can be measured in accordance with JIS R 1634:1998 or JIS R2205:1992.

When the porosity is 0.01% or more, gas permeability of the mold 10 is ensured, and a gas in a space between the glass to be molded 13 and the mold 10 is easily escaped during molding, so that a molding defect due to a gas can be suppressed. When the porosity is 40% or less, preferably 20% or less, the density of the glass G is increased and not only the durability of the mold 10 is enhanced but also the molding surface 11 having good flatness is provided, so that surface shape and translucency of the bent glass 50 molded following the molding surface 11 can be improved.

The thermal conductivity at 500° C. of the glass G is preferably from 0.1 W/(m·K) to 10 W/(m·K), more preferably from 0.3 W/(m·K) to 1.0 W/(m·K). The thermal conductivity in this range is effective for suppressing warpage of the glass due to thermal change.

The thermal conductivity at 500° C. can be measured in accordance with JIS R2616:2001.

When the thermal conductivity at 500° C. of the mold 10 is 1.0 W/(m·K) or less, the heat capacity (thermal conduction×density) of the mold 10 is small, and the energy cost for heating can be reduced. In addition, as the porosity is larger, the energy efficiency can be enhanced, because the density is lower and the heat capacity is smaller. When the thermal conductivity at 500° C. of the mold 10 is 0.1 W/(m·K) or more, cooling from inside the mold 10 is expedited after molding, and the heat cycle rate is increased, and as a result, the productivity can be enhanced.

Here, the reason for employing the temperature of 500° C. for the thermal conductivity is that a variety of glass often have a glass transition temperature of 500° C. or more and since the temperature immediately before behaving as an elastic body is generally around 500° C., it is easy to compare a variety of glass under identical conditions.

The glass transition temperature can be measured in accordance with JIS R3103-3:2001.

The glass transition temperature of the glass G is preferably from 1,000° C. to 1,500° C. for ensuring heat resistance during molding and is preferably 1,200° C. or more for unfailingly preventing out-of-shape during high temperature molding. The composition of the glass G of the mold 10 is not particularly limited, but a composition containing from 95 to 99.9% of SiO₂ is preferred.

The coefficient of thermal expansion at 1,000° C. of the glass G is preferably from 0.01% to 0.1%. When the coefficient of thermal expansion is 0.01% or more, the difference in coefficient of thermal expansion from a glass for molding can be made small, and when it is 0.1% or less, the deviation from the design after molding can be reduced. Here, assuming that the length of the glass G in an ordinary temperature state (e.g., 20° C.) is L₀ and the length of the glass G at 1,000° C. is L, the coefficient of thermal expansion of the glass G is calculated as |L−L₀|/L×100(%).

The difference in coefficient of thermal expansion at 500° C. or less between the mold 10 and the glass to be molded 13 is preferably 1.0×10⁻⁵/° C. or less. If the different in expansion coefficient between both is large, the mold 10 may be frictioned with the bent glass 50 due to the difference in thermal shrinkage to generate scratches on the surface of the bent glass 50.

The glass G is sufficient if the thermal conductivity at 500° C. is from 0.1 W/(m·K) to 10 W/(m·K) or the coefficient of thermal expansion at 1,000° C. is from 0.01% to 0.1%. It may also be possible to satisfy both requirements.

Microvoids defined by pores within the mold 10 are preferably formed so as to communicate with each other. The microvoids communicating within the mold 10 effectively function in suctioning a gas in a space between the molding surface 11 and the glass to be molded 13 from a suction path 29 on the bottom surface of the mold 10 during molding a bent glass 50 from the glass to be molded 13 by a vacuum molding process.

The porosity of the mold 10 may be uniform throughout the entirety or may have a distribution in the sheet thickness direction of the glass G. In the case where the porosity has a distribution in the sheet thickness direction, for example, when the porosity in the glass G surface is 0.01% and the porosity inside the glass G exceeds 10%, an air suctioned from the molding surface 11 of the mold 10 can easily move inside the mold 10, and the gas permeability of the mold 10 is enhanced. In addition, since the porosity in the glass G surface is lower than the porosity inside the glass G, the surface of the molding surface 11 is dense compared with the inside of the glass G. As a result, the bent glass 50 having good surface profile can be molded. Furthermore, when the surface of the molding surface 11 is mirror-finished, the surface profile of the bent glass 50 is smoother. Here, the “inside of the glass G” is not particularly limited and can be, in cross-sectional viewing at a certain site, a region corresponding to 20% or more of the glass thickness from the molding surface 11.

The molding surface 11 has an arithmetic surface roughness Ra of 2.5 μm or less and an arithmetic average waviness Wa of 1.6 μm or less, preferably an arithmetic surface roughness Ra of 1.0 μm or less and an arithmetic average waviness Wa of 0.4 μm or less. Within these ranges, scratches are less likely to be generated on the bent glass 50 molded, and the accuracy of transmission distortion of glass is enhanced. Here, Ra and Wa are values measured by the methods stipulated in JIS B 0601 (2013).

In addition, when a coat P such as SiO₂, SiC, Al₂O₃, Pt, Ir, W, Re, Ta, Rh, Ru, Os, C, Ta, Ti and Ni is formed on the molding surface 11, the releasability of the bent glass 50 from the mold 10 is enhanced, and this can contribute to the improvement of productivity.

In the mold 10, in order to accurately adjust the position of the glass to be molded 13, a position-alignment part (not shown) such as pin, ridge part, other projection parts, etc. is preferably provided at the predetermined position of the molding surface 11. The position-alignment part may be provided as a separate body from the mold 10 or may be provided by grinding a part of the mold 10. When a position-alignment part is provided on the molding surface 11, the glass to be molded 13 can be more accurately arranged on the mold 10.

As for the base 21, the mold 10 is fixed on the top surface of the base, and the glass to be molded 13 can be placed on the mold 10. Inside the base 21, a suction path 29 for adsorbing the glass to be molded 13 placed on the mold 10 to the molding surface 11 may be formed.

The cover member 23 is attached to the base 21 to cover the periphery of the mold 10.

The cover member 23 covering the mold 10 is effective in keeping the neighborhood of the mold 10 clean and, for example, a metal plate such as stainless steel can be used. A material such as glass or glass ceramic may also be used, or similarly to the base 21, a material having the same composition as the material of the mold 10 may be used as well.

The heater 25 is disposed, for example, at a predetermined distance above the cover member 23. As the heater 25, a radiation heater such as near-infrared heater or middle-infrared heater, or an atmosphere-heating type heater can be used, and a short-wavelength infrared heater having high heating efficiency is preferred. The heater 25 emits radiant heat from outside the cover member 23 to heat the cover member 23, and the glass to be molded 13 disposed inside the cover member 23 is indirectly heated by heat stored in the cover member 23 and is heated to a temperature not less than the softening point.

In the cover member 23, the transmittance of light having a wavelength of 0.5 to 2.5 μm is preferably 50% or more. A material capable of transmitting the light at a rate of more preferably 70% or more, still more preferably 80% or more, may be used. The glass to be molded 13 is heated by radiant heat emitted from the heater 25, radiant heat emitted from the cover member 23, and convection heating, whereby heating of the glass to be molded 13 can be uniformized and cracking of the glass to be molded 13 during heating can be prevented. As the upper limit of the above-described transmittance of the cover member 23, it is preferably 98% or less, more preferably 93% or less. In this case, the cover member 23 can appropriately absorb near-infrared ray, etc. from the heater 25 and store the heat.

The transmittance can be calculated based on the calculation method as described in, e.g. ISO 9050: 2003 or JIS R 3106: 1998.

The suction pump 27 functions as a negative pressure supply part that suctions air in a space between the mold 10 and the glass to be molded 13 through a suction path 29 formed in the base 21.

The base 21 is preferably composed of a material having the same composition as the material of the mold 10. For example, when the base 21 is composed of a material containing 99% or more of SiO₂, the oxidation resistance during heating is improved and moreover, since the coefficient of thermal expansion is close to that of the mold 10, the difference in thermal expansion is advantageously reduced.

The base 21 may also be composed of a material having oxidation resistance, such as stainless steel where an oxidation-resistant coat is formed on the base surface. As the composition of the glass to be molded 13, for example, soda lime glass, aluminosilicate glass, borosilicate glass, and lithium disilicate glass can be used. Among them, in this embodiment, it is excellent particularly when aluminosilicate glass or borosilicate glass is used for the glass to be molded 13. Such a glass to be molded 13 has a high Young's modulus and a high expansion coefficient and is readily broken upon rapid heating by a conventional heating device, because heating of the glass to be molded generates a high thermal stress. When the metal mold of this embodiment is used, the glass to be molded 13 can be heated gently and uniformly, and the productivity can thereby be enhanced.

Specific examples of the glass composition includes glass containing, as a composition represented by mol %, from 50% to 80% of SiO₂, from 0.1% to 25% of Al₂O₃, from 3% to 30% of Li₂O+Na₂O+K₂O, from 0% to 25% of MgO, from 0% to 25% of CaO, and from 0% to 5% of ZrO₂, but the glass composition is not particularly limited. More specifically, examples of the glass composition include the following glass compositions. Here, for example, the phrase “containing from 0% to 25% of MgO” means that MgO is not essential but may be contained up to 25%. The glass (i) is encompassed by soda lime silicate glass, and the glasses (ii) and (iii) are encompassed by aluminosilicate glass.

(i) Glass containing, as a composition represented by mol %, from 63% to 73% of SiO₂, from 0.1% to 5.2% of Al₂O₃, from 10% to 16% of Na₂O, from 0% to 1.5% of K₂O, from 0% to 5% of Li₂O, from 5% to 13% of MgO, and from 4% to 10% of CaO.

(ii) Glass containing, as a composition represented by mol %, from 50% to 74% of SiO₂, from 1% to 10% of Al₂O₃, from 6% to 14% of Na₂O, from 3% to 11% of K₂O, from 0% to 5% of Li₂O, from 2% to 15% of MgO, from 0% to 6% of CaO, and from 0% to 5% of ZrO₂, wherein the total of the contents of SiO₂ and Al₂O₃ is 75% or less, the total of the contents of Na₂O and K₂O is from 12% to 25%, and the total of the contents of MgO and CaO is from 7% to 15%.

(iii) Glass containing, as a composition represented by mol %, from 68% to 80% of SiO₂, from 4% to 10% of Al₂O₃, from 5% to 15% of Na₂O, from 0% to 1% of K₂O, from 0% to 5% of Li₂O, from 4% to 15% of MgO, and from 0% to 1% of ZrO₂.

(iv) Glass containing, as a composition represented by mol %, from 67% to 75% of SiO₂, from 0% to 4% of Al₂O₃, from 7% to 15% of Na₂O, from 1% to 9% of K₂O, from 0% to 5% of Li₂O, from 6% to 14% of MgO, and from 0% to 1.5% of ZrO₂, wherein the total of the contents of SiO₂ and Al₂O₃ is from 71% to 75%, the total of the contents of Na₂O and K₂O is from 12% to 20%, and in the case of containing CaO, the content thereof is less than 1%.

In the case of using the glass to be molded 13 by coloring it, a coloring agent may be added as long as it does not inhibit the achievement of the desired chemical-strengthening properties. Suitable examples of the coloring agent include Co₃O₄, MnO, MnO₂, Fe₂O₃, NiO, CuO, Cu₂O, Cr₂O₃, V₂O₅, Bi₂O₃, SeO₂, TiO₂, CeO₂, Er₂O₃, and Nd₂O₃, which are oxides of Co, Mn, Fe, Ni, Cu, Cr, V, Bi, Se, Ti, Ce, Er, and Nd, respectively.

In the case of using the colored glass, the glass may contain, as represented by mol percentage on the oxide basis, 7% or less of a coloring component (at least one component selected from the group consisting of oxides of Co, Mn, Fe, Ni, Cu, Cr, V, Bi, Se, Ti, Ce, Er and Nd). When the content of the coloring component exceeds 7%, the glass is likely to be devitrified. The content of the coloring component is more preferably 5% or less, still more preferably 3% or less, yet still more preferably 1% or less. In the case of placing a priority on the visible light transmittance of a glass to be molded, the above-described components are typically not incorporated.

The glass to be molded 13 may appropriately contain SO₃, chloride, fluoride, etc. as a fining agent during melting.

As to one example of the production process for the bent glass by using the molding apparatus 100, the outline of each step is described below.

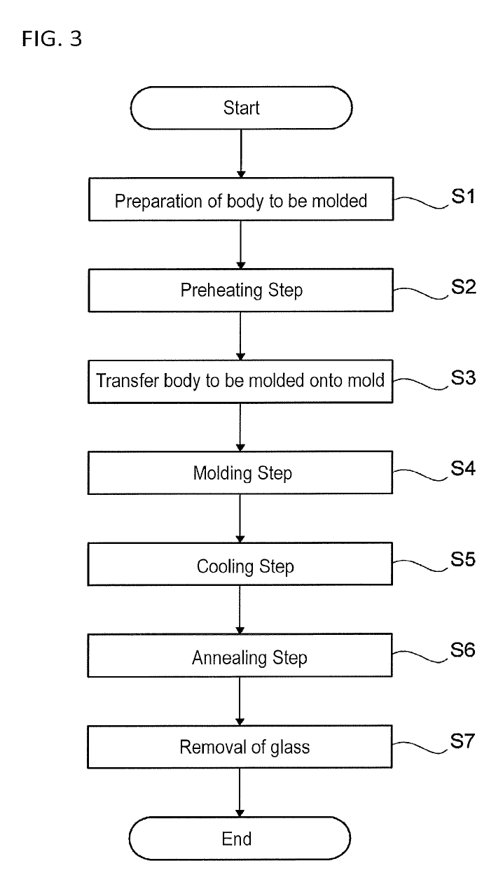

FIG. 3 shows a flowchart illustrating the procedure of the production process of bent glass.

First, a glass to be molded 13 as a body to be molded is prepared in the processable state by supporting it by appropriate support means such as support stand, lower mold and arm (S1).

The prepared glass to be molded 13 is heated to a temperature lower than the softening point, for example, at about 500° C., in the preheating step and thereafter heated to provide an equilibrium viscosity of about 10^{14.5} Pa·s (S2). This preheating step makes it possible to prevent generation of damages such as crack generated when the glass to be molded 13 is rapidly heated to near the softening point.

The glass to be molded 13 after preheating is then moved or transported onto the mold 10, and as illustrated in FIG. 2, the periphery of the mold 10 is covered with the cover member 23 (S3).

Radiant heat is emitted from the heater 25 to heat the glass to be molded 13 disposed inside the cover member 23, for example, to a temperature not less than the softening point of 700° C. to 750° C. such that the equilibrium viscosity becomes from 10^{7.5} Pa·s to 10¹¹ Pa·s. The glass to be molded 13 heated to a temperature not less than the softening point is gradually curved downward by means of gravity and negative pressure supplied by the suction pump 27.

More specifically, when air at the bottom surface of the mold 10 is suctioned by supplying a negative pressure to the suction path 29 on the bottom surface of the mold 10 by the suction pump 27, air is suctioned to the bottom surface of the mold 10 from the molding surface 11 through pores defined by microvoids within the mold 10. As a result, a low pressure is produced in a space between the molding surface 11 and the glass to be molded 13, and the first main surface 13a of the softened glass to be molded 13 is adsorbed to the molding surface 11, whereby the shape of the molding surface 11 is transferred to the glass to be molded 13.

In this way, the glass to be molded 13 is molded to follow the molding surface 11, thereby being molded into a bent glass 50 having a curvature part having the same shape as the molding surface 11 (S4).

The preheating step conducted before the molding step may be conducted for the glass to be molded 13 alone separately from the mold 10 but may be conducted for the mold 10 on which the glass to be molded 13 is placed. In this case, transportation after preheating is unnecessary. In addition, when the mold 10 used before is cyclically used upon temperature reduced to 400° C. without waiting until the temperature is reduced to room temperature, the production cycle is shortened and not only the productivity is enhanced but also the energy consumption can be reduced.

The bent glass 50 after the formation of curvature part is once cooled to room temperature in the cooling step (S5). Thereafter, the glass is heated, for example, to an annealing temperature of 550° C. such that the equilibrium viscosity becomes from 10^{12.5} Pa·s to 10¹⁷ Pa·s, and held at this annealing temperature for a predetermined time (S6). By this annealing step, internal stress remaining in the molded bent glass 50 is removed. The annealing step may be a step conducted continuously after the molding step.

The bent glass 50 subjected to annealing is cooled to near room temperature, and then, the bent glass 50 is removed from the mold 10 (S7). Molding and annealing of the bent glass 50 are completed through these steps.

In the mold 10 described above, since the mold material is a glass, the materials of the body to be molded and the mold have the same quality, and the difference in coefficient of thermal expansion during heating is small, so that the molding accuracy can be enhanced. In addition, the mold surface is a glass and has good resistance to abrasion and corrosion and high durability, and unlike the carbon mold, dust is not generated. Furthermore, even when the molding process is performed in an air atmosphere, the mold is not deteriorated due to oxidation, etc., and it is therefore possible to make the processing equipment simple and reduce the production cost.

The mold 10 is composed of a glass having a porosity of 0.01% or more, and the gas permeability can thereby be ensured, and as a result, remaining of a gas in a space between the glass to be molded 13 and the molding surface 11 during molding is suppressed. Consequently, even under harsh molding conditions, occurrence of molding failure can be prevented, and the surface property or profile of the bent glass after molding is in good state as designed. In addition, the processability of the mold 10 is good due to presence of pores, and the demand for the growth in mold size can be easily coped with.

In the case where the porosity of the mold 10 is 40% or less, the surface of the molding surface 11 is smooth, and fine concave-convex shape can be avoided from transferring to the body to be molded. Accordingly, the surface of the molded bent glass can have smooth property with excellent aesthetic appearance.

In addition, according to this configuration, the first main surface of the bent glass 50 comes into contact with the molding surface 11a of the mold 10, but the bent glass 50 is molded while keeping the second main surface from contacting any member, so that generation of a concave-convex region such as scratch and dent in the second main surface can be reduced. Accordingly, from the viewpoint of enhancing the visibility, the second main surface is preferably assigned to the surface on the outer side of the assembly body, i.e., the surface to be touched by user(s) in a normal usage state.

Furthermore, the difference in coefficient of thermal expansion can be reduced between the mold 10 and the body to be molded, and friction between the mold 10 and the bent glass 50 is suppressed during cooling after molding, and as a result, scratching can be prevented.

The mold 10 during heating is placed on the base 21 formed of a material having the same composition as that of the mold 10, and the periphery is entirely covered with the cover member 23. Accordingly, fouling such as attachment of externally entering foreign matter to the surface of the glass to be molded 13 is not occurred. In addition, since radiant heat from the heater 25 is transmitted to the body to be molded through the cover member 23, the body to be molded can be evenly heated, and heating unevenness is less likely to occur. Consequently, the occurrence of local thermal strain can be prevented, and highly accurate molding can be realized.

### Second Configuration Example

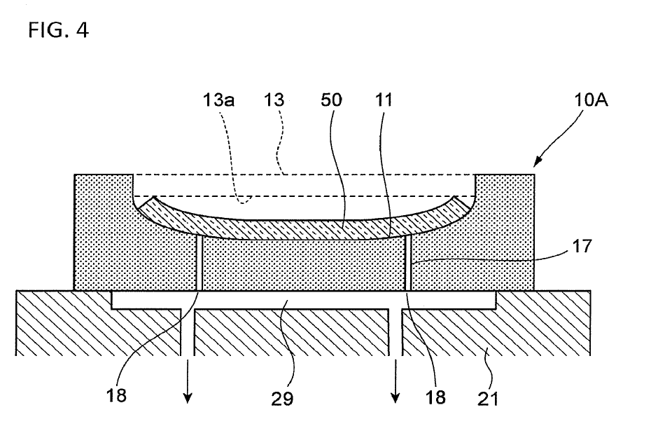

FIG. 4 is a cross-sectional view of a main part of a molding apparatus illustrating a second configuration example of the mold.

In the mold 10A of this configuration, a suction hole 17 extended from the molding surface 11 to the back surface on the opposite side of the molding surface 11 is formed. The opening 18 of the suction hole 17 open to the back surface of the mold is arranged to face the suction path 29, and a negative pressure from the suction path 29 is supplied to the suction hole 17.

In this mold 10A, the glass to be molded 13 is caused to follow the molding surface 11 by supplying a negative pressure to the suction path 29 and the suction hole 17 by a suction pump (not shown). In this case, a negative pressure is supplied from the suction path 29 to the molding surface 11 side through voids of the mold 10A and since a negative pressure is directly supplied to the molding surface 11 side also from the suction hole 17, the supply speed of the negative pressure is increased. Consequently, the glass to be molded 13 can contact the molding surface 11 in a shorter time to improve the tact time of the molding step.

The suction hole 17 is not necessarily required to penetrate to the molding surface 11 but may be sufficient if it communicates with the molding surface 11 through voids present within the mold 10. The suction hole 17 can be arranged at an arbitrary position of the molding surface 11 without being limited to the illustrated example. In addition, when the arrangement density of suction holes 17 in the bent region is larger than the arrangement density in a relatively flat region of the molding surface 11, the shape transferability to the body to be molded can be more enhanced. As for actions and effects of this configuration, the same actions and effects as in the first configuration example are obtained.

### Third Configuration Example

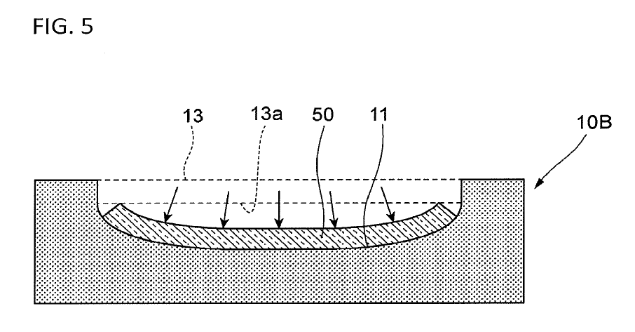

FIG. 5 is a cross-sectional view of a main part of a molding apparatus illustrating a third configuration example of the mold.

The mold 10B of this configuration molds a bent glass 50 by a gravity molding process.

In the gravity molding process, a glass to be molded 13 is placed on the mold 10, and the glass to be molded 13 is heated, softened and deformed downward by its own weight. As a result, the first main surface 13a of the glass to be molded 13 is brought into contact with the molding surface 11, and the shape of the molding surface 11 is transferred to the glass to be molded 13.

In the mold 10B of this configuration, a negative pressure need not to be supplied, and installation of a suction pump or a suction channel is unnecessary. In addition, the negative pressure supplied, the timing of supply, etc. need not be controlled, and the configuration of the molding apparatus and the control for molding can be simplified. As for actions and effects of this configuration, the same actions and effects as in the first configuration example are obtained.

### Fourth Configuration Example

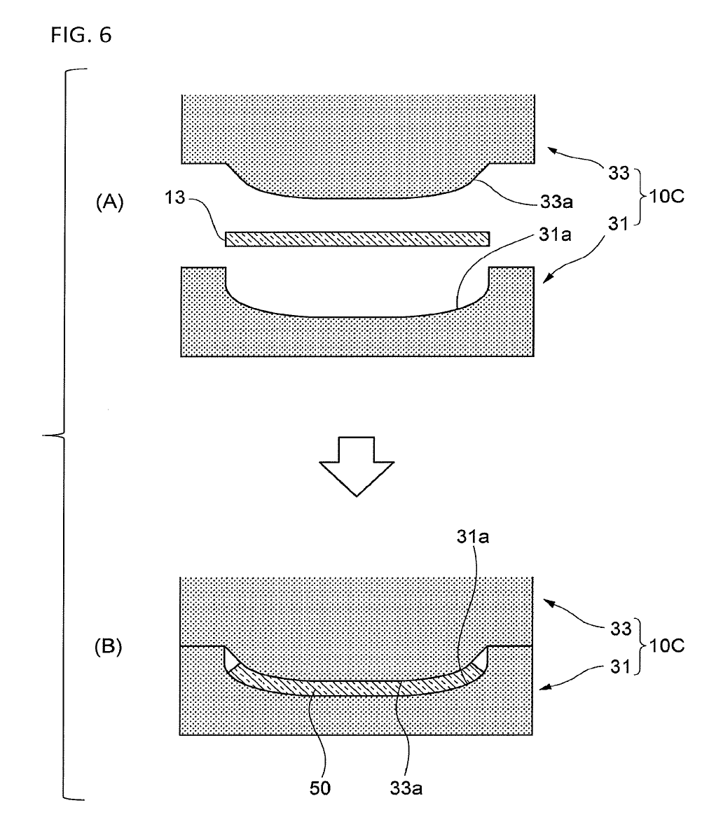

FIG. 6 is cross-sectional views of a main part of a molding apparatus illustrating a fourth configuration example of the mold.

The mold 10C of this configuration molds a bent glass 50 by a press molding process.

The mold 10C has a pair of opposing molds 31 and 33 disposed to face each other. One opposing mold 31 is a fixed mold and has the same configuration as the mold 10B of the third configuration example above. The other opposing mold 33 is a movable mold and is provided to be capable of sliding toward the opposing mold 31. The opposing mold 33 has a downwardly projecting molding surface 33a working out to a male mold of the bent glass 50. A glass to be molded 13 as a body to be molded is supplied between the opposing mold 31 and the opposing mold 33 and in the state of the glass to be molded 13 being heated and softened, a press load is applied to the opposing mold 33 to create a mold clamped state illustrated in the view (B) of FIG. 6 from a mold opened state illustrated in the view (A) of FIG. 6. As a result, the glass to be molded 13 is molded into a shape following respective molding surfaces 31a and 33a of the opposing molds 31 and 33. The opposing molds 31 and 33 may be mutually movable molds, and it is sufficient if at least either one opposing mold is movable.

In the mold 10C of this configuration, the bent glass 50 can be molded by press molding using a pair of opposing molds 31 and 33 and can be molded with high accuracy at high speed. Accordingly, a bent glass having stable quality can be molded and moreover, the tact time can be reduced.

In addition, annealing can be performed while keeping the bent glass 50 in a molded state by a pair of opposing molds 31 and 33. In this case, the bent glass 50 can be prevented from a shape change due to heating. Accordingly, a high-quality bent glass can be stably obtained with high efficiency. As for actions and effects of this configuration, the same actions and effects as in the first configuration example are obtained.

As described above, the present invention is not limited to these embodiments, and aspects in which respective configurations of the embodiments are combined or one skilled in the art makes changes or applications based on the description of the specification and known techniques are encompassed by the scope of protection required herein.

For example, the glass to be molded or the bent glass (hereinafter, referred to as a material to be processed) may be subjected to the following steps/treatments.

At least one main surface of the material to be processed may be subjected to a grinding/polishing process.

### (Edge Processing/Drilling Step)

The end face of the material to be processed may be subjected to a treatment such as chamfering. In general, a processing called R-chamfering or C-chamfering is preferably conducted by mechanical grinding, but the processing may be performed by etching, etc. and is not particularly limited. It may also be possible to previously subject a plate-like glass to be molded to edge processing and then fabricate a bent glass through the molding step.

Regardless of before or after the molding step, the material to be processed may be subjected to a drilling or cutting process.

### (Strengthening Step)

As strengthening treatment methods of forming a surface compressive stress layer in a material to be processed, physical strengthening methods or chemical strengthening methods can be utilized. A material to be processed a glass main surface of which has been subjected to a strengthening treatment is high in mechanical strength. Any of the strengthening methods can be applied, but from the standpoint of obtaining a material to be processed which is thin and has a high surface compressive stress (CS) value, a chemical strengthening method is preferably conducted.

The strengthening step is preferably conducted after the molding step.

### (Chemical Strengthening Step)

A material to be processed may be subjected to a chemical strengthening to form a compressive stress layer in the surface thereof, thereby enhancing strength and scratch resistance. The chemical strengthening is a treatment that alkali metal ions (typically Li ion or Na ion) having smaller ionic radius of a glass surface is exchanged with alkali metal ions (typically Na ion for the Li ion, and K ion for the Na ion) having larger ionic radius by ion exchange at a temperature equal to or less than a glass transition point thereof, thereby forming a compressive stress layer in the glass surface. The chemically strengthening treatment can be carried out by a conventional method. Generally, a glass is dipped in a potassium nitrate molten salt. 10 mass % or less of potassium carbonate may be incorporated into the molten salt, and the resulting mixture may be used. By this, cracks on a surface layer of the glass can be removed, and a glass having high strength can be obtained. In addition, potassium nitrate mixed salt in which sodium nitrate or the like is mixed may be used, and water vapor or carbon dioxide may be blew into the potassium nitrate molten salt. When a silver component such as silver nitrate is mixed with potassium nitrate during chemical strengthening, the glass has ion-exchanged silver ion in the surface thereof. As a result, antibiotic properties can be given to the glass.

### (Surface Treatment Step)

With respect to the material to be processed, a step of forming various surface treatment layers may be conducted, if desired. Examples of the surface treatment layer include an antiglare treatment layer, an antireflection treatment layer, an antifouling treatment layer, etc., and these may be used in combination. The surface treatment may be either the first main surface or the second main surface of the material to be processed. The layer above is preferably formed after the molding step or the annealing step, but the antiglare treatment layer may be formed before the molding step.

### [Antiglare Treatment Layer]

The antiglare treatment layer is a layer producing an effect of scattering mainly reflected light and thereby reducing the glare of reflected light due to reflection of light source. The antiglare treatment layer may be formed by processing the surface of the material to be processed or may be separately deposited and formed. As the method for forming the antiglare treatment layer, for example, a method of forming a concave-convex profile with a desired surface roughness by at least partially subjecting the material to be processed to a surface treatment by chemical (e.g., etching) or physical (e.g., sandblast) method may be used. In addition, as the formation method, a processing solution may be applied to or sprayed on at least a part of the material to be processed to form a concave-convex structure on the plate.

Furthermore, a concave-convex structure may be formed on at least a part of the material to be processed by a thermal method.

### [Antireflection Treatment Layer]

The antireflection treatment layer is a layer that produces an effect of reducing the reflectance, bringing reduction in the glare due to reflection of light, and in the case of using it for a display device, can increase the transmittance of light from the display device and improve the visibility of the display device.

In the case where the antireflection treatment layer is an antireflection film, the film is preferably formed on the first main surface or the second main surface of the material to be processed with no limitation. The configuration of the antireflection film is not limited as long as the reflection of light can be inhibited, and the film may have, for example, a configuration including a laminate of a high-refractive-index layer having a refractive index in a wavelength of 550 nm of 1.9 or more and a low-refractive-index layer having a refractive index in a wavelength of 550 nm of 1.6 or less, or a configuration including a layer having a refractive index in a wavelength of 550 nm of 1.2 to 1.4 and including a film matrix having mixed therein hollow particles or pores.

### [Antifouling Treatment Layer]

The antifouling treatment layer is a layer for inhibiting attachment of an organic substance and an inorganic substance to the surface, or even when an organic substance or an inorganic substance is attached to the surface, for facilitating removal of the attached substance by cleaning such as wiping-off.

In the case where the antifouling treatment layer is formed as an antifouling film, the film is preferably formed on the first main surface and the second surface of the material to be processed or on other surface treatment layer. The antifouling treatment is not limited as long as an antifouling property can be imparted. Among them, the film is preferably composed of a fluorine-containing organic silicon compound coat obtained by a hydrolysis and condensation reaction of a fluorine-containing organic silicon compound.

(Formation of Printed layer)

A printed layer may be formed by various kinds of printing methods and inks (material to be printed) depending on applications thereof. As the printing methods, examples thereof include a spray printing, an ink jet printing, and a screen printing. By these methods, good printing can be conducted even in the case of using a material to be processed which has a large area. In particular, by using the spray printing, printing is easily performed on a material to be processed which has a curvature part and the surface roughness of a printed layer is easily controlled. In the case of using screen printing, a desired print pattern is easily formed so as to have uniform average thickness in a material to be processed which has a large area. In addition, a plurality of inks may be used. From the standpoint of adhesiveness of a printed layer, one kind of ink is preferably used. The inks for forming the printed layer may be an inorganic ink or an organic ink.

The present invention is not limited to the application to a mold but in addition, can be applied to various jigs and members to be used when performing a treatment in a high-temperature atmosphere, as exemplified by an annealing jig for supporting a glass to be molded during annealing process, a jig for transporting a glass to be molded, and an abutment pin for position alignment, etc.

### Examples

Working examples of the present invention are described below. The present invention is not limited to the following working examples.

### [Production Steps of Molded Glass]

Molded glass was produced by the procedure including preparation of a glass base material as the body to be molded (S1), a preheating step (S2), a molding step (S4), and a cooling step (S5).

[Preparation of Glass to be molded (S1)]

As the glass to be molded 13, aluminosilicate glass having a main surface size of 150 mm×200 mm and a thickness of 1.1 mm (Dragontrail (registered trademark), manufactured by Asahi Glass Co., Ltd.) was used.

### [Heating Device]

Using a molding apparatus 100 illustrated in FIG. 2 including a base 21, a cover member 23, and a heater 25, a glass to be molded 13 was arranged as described later, and the molded glass was produced. The glass to be molded 13 was placed on a mold 10 illustrated in FIG. 5 having a shape making it possible to obtain the desired bent glass 50.

As the base 21, a glass ceramic containing, as a composition represented by mol %, 99% or more of SiO₂ was used. As the cover member 23, the same material as the base 21 was used. As the heater 25, a heater by short-wavelength radiation heating was used.

The mold 10 was produced using a glass having a porosity of 10%, a thermal conductivity at 500° C. of 0.58 W/(m·K), and a coefficient of thermal expansion at 1,000° C. of 0.05%.

### [Preheating Step (S2)]

In the preheating step, the cover member 23 was previously heated up to about 200° C., and temperature rise by the heater 25 was started at the moment when the glass to be molded 13 placed on the mold 10 was moved below the heated cover member 23. Heating was performed up to about 560° C. such that the equilibrium viscosity of the glass to be molded 13 became about 10^{14.5} Pa·s.

### [Molding Step (S4)]

In the molding step, the glass was further heated up to about 750° C. such that the equilibrium viscosity became about 10^{8.6} Pa·s. After the glass to be molded 13 could be maintained at a desired temperature, molding was conducted using a gravity molding process by causing the glass to follow the mold 10, and a bent glass 50 was thereby obtained.

### [Cooling Step (S5)]

After the completion of molding step, electrification to the heater 25 was stopped, and the molding apparatus and the molded glass were cooled for 20 minutes such that the equilibrium viscosity of the bent glass 50 became about 10¹⁹ Pa·s.

The same operation was conducted 5 times by the above product step of the bent glass. There was no cracked or chipped glass in the obtained bent glass, and scratch was not observed in the main surface contacted with the mold. High productivity could be confirmed by this embodiment. In addition, even when temperature rise and cooling were repeated, dust was not generated from the mold, and a defect derived from the mold was not found.

As described above, the following aspects are described in the present specification.

(1) A mold having a molding surface for hot molding of a body to be molded,

the mold comprising a glass having a porosity of 0.01% or more and containing 95 mol % or more of SiO₂.

(2) The mold according to (1), wherein the glass has a thermal conductivity at 500° C. of 0.1 W/(m·K) to 1.0 W/(m·K).

(3) The mold according to (1) or (2), wherein the glass has a coefficient of thermal expansion at 1,000° C. of 0.01% to 0.1%.

(4) The mold according to any one of (1) to (3), wherein the glass has the porosity of 40% or less.

(5) The mold according to any one of (1) to (4), wherein the glass has a larger porosity inside the mold than a porosity in the molding surface.

(6) The mold according to any one of (1) to (5), wherein the molding surface has at least partially a curvature part.

(7) The mold according to any one of (1) to (6), wherein the molding surface has an arithmetic average roughness Ra of 2.5 μm or less.

(8) The mold according to any one of (1) to (7), wherein the molding surface has an arithmetic average waviness Wa of 1.6 μm or less.

(9) The mold according to any one of (1) to (8), wherein the glass has a glass transition temperature of 1,000° C. to 1,500° C.

(10) The mold according to any one of (1) to (9), wherein the molding surface has a coat containing any one of SiO₂, SiC, Al₂O₃, Pt, Ir, W, Re, Ta, Rh, Ru, Os, C, Ta, Ti and Ni.

(11) A molding apparatus comprising:

the mold according to any one of (1) to (10);

a base for fixing the mold;

a cover member which is attached to the base and covers the periphery of the mold; and

a heater for heating the mold from outside the cover member.

(12) The molding apparatus according to (11), wherein

the mold comprises a suction hole extended from the molding surface to a back surface on the opposite side of the molding surface, and

the molding apparatus further comprises a negative pressure supply part that supplies a negative pressure through the suction hole.

(13) A method for producing a bent glass, the method comprising:

a placing step of placing a glass to be molded, on a mold comprising a glass having a porosity of 0.01% or more; and

a molding step of heating the glass to be molded which has been placed on the mold, thereby causing the glass to be molded to follow a molding surface of the mold.

(14) The method according to (13), wherein the glass has a thermal conductivity at 500° C. of 0.1 W/(m·K) to 1.0 W/(m·K).

(15) The method according to (13) or (14), wherein the glass has a coefficient of thermal expansion at 1,000° C. of 0.01% to 0.1%.

(16) The method according to any one of (13) to (15), wherein the molding step is conducted in an air atmosphere.

(17) The method according to any one of (13) to (16), further comprising a preheating step of heating the glass to be molded before the molding step.

(18) The method according to any one of (13) to (17), wherein in the molding step, the glass to be molded which has been heated is caused to follow the molding surface by gravity.

(19) The method according to any one of (13) to (18), wherein

the mold comprises a suction hole open to the molding surface, and

in the molding step, a negative pressure is supplied to the suction hole, thereby adsorbing the glass to be molded onto the molding surface.

(20) The method according to any one of (13) to (19), wherein the mold comprises a pair of opposing molds disposed to face each other and the glass to be molded is press-molded between a molding surface of one of the opposing molds and a molding surface of the other of the opposing molds.

(21) The method according to any one of (13) to (20), further comprising a cutting step of cutting a bent glass obtained, after the molding step.

(22) The method according to any one of (13) to (21), further comprising a strengthening step of strengthening a bent glass obtained, after the molding step.

(23) The method according to (22), wherein the strengthening step is a chemical strengthening step.

(24) The method according to any one of (13) to (23), further comprising a printing step of forming a printed layer on a bent glass obtained, after the molding step.

### DESCRIPTION OF REFERENCE NUMERALS AND SIGNS

10, 10A, 10B, 10C Mold
11 Molding surface
13 Glass to be molded (Body to be molded)
17 Suction hole
21 Base
23 Cover member
25 Heater
27 Suction pump
31, 33 Opposing mold
50 Bent glass (glass having curvature part)
100 Molding apparatus
G Glass

1. A mold having a molding surface for hot molding of a body to be molded,
the mold comprising a glass having a porosity of 0.01% or more and containing 95 mol % or more of SiO₂.

2. The mold according to claim 1, wherein the glass has a thermal conductivity at 500° C. of 0.1 W/(m·K) to 1.0 W/(m·K).

3. The mold according to claim 1, wherein the glass has a coefficient of thermal expansion at 1,000° C. of 0.01% to 0.1%.

4. The mold according to claim 1, wherein the glass has the porosity of 40% or less.

5. The mold according to claim 1, wherein the glass has a larger porosity inside the mold than a porosity in the molding surface.

6. The mold according to claim 1, wherein the molding surface has at least partially a curvature part.

7. The mold according to claim 1, wherein the molding surface has an arithmetic average roughness Ra of 2.5 μm or less.

8. The mold according to claim 1, wherein the molding surface has an arithmetic average waviness Wa of 1.6 μm or less.

9. The mold according to claim 1, wherein the glass has a glass transition temperature of 1,000° C. to 1,500° C.

10. The mold according to claim 1, wherein the molding surface has a coat containing any one of SiO₂, SiC, Al₂O₃, Pt, Ir, W, Re, Ta, Rh, Ru, Os, C, Ta, Ti and Ni.

11. A molding apparatus comprising:
the mold according to claim 1;
a base for fixing the mold;
a cover member which is attached to the base and covers the periphery of the mold; and
a heater for heating the mold from outside the cover member.

12. The molding apparatus according to claim 11, wherein
the mold comprises a suction hole extended from the molding surface to a back surface on the opposite side of the molding surface, and
the molding apparatus further comprises a negative pressure supply part that supplies a negative pressure through the suction hole.

13. A method for producing a bent glass, the method comprising:
a placing step of placing a glass to be molded, on a mold comprising a glass having a porosity of 0.01% or more; and
a molding step of heating the glass to be molded which has been placed on the mold, thereby causing the glass to be molded to follow a molding surface of the mold.

14. The method according to claim 13, wherein the glass has a thermal conductivity at 500° C. of 0.1 W/(m·K) to 1.0 W/(m·K).

15. The method according to claim 13, wherein the glass has a coefficient of thermal expansion at 1,000° C. of 0.01% to 0.1%.

16. The method according to claim 13, wherein the molding step is conducted in an air atmosphere.

17. The method according to claim 13, further comprising a preheating step of heating the glass to be molded before the molding step.

18. The method according to claim 13, wherein in the molding step, the glass to be molded which has been heated is caused to follow the molding surface by gravity.

19. The method according to claim 13, wherein
the mold comprises a suction hole open to the molding surface, and
in the molding step, a negative pressure is supplied to the suction hole, thereby adsorbing the glass to be molded onto the molding surface.

20. The method according to claim 13, wherein the mold comprises a pair of opposing molds disposed to face each other and the glass to be molded is press-molded between a molding surface of one of the opposing molds and a molding surface of the other of the opposing molds.

21. The method according to claim 13, further comprising a cutting step of cutting a bent glass obtained, after the molding step.

22. The method according to claim 13, further comprising a strengthening step of strengthening a bent glass obtained, after the molding step.

23. The method according to claim 22, wherein the strengthening step is a chemical strengthening step.

24. The method according to claim 13, further comprising a printing step of forming a printed layer on a bent glass obtained, after the molding step.
